(19) United States
(12) Patent Application Publication
(10) Pub. No.: US 2015/0095197 A1
(43) Pub. Date: Apr. 2, 2015

(54) SYSTEMS AND METHODS FOR MINIMIZING TRAVEL COSTS FOR USE OF TRANSPORTATION PROVIDERS BY A USER

(71) Applicant: David Edward Eramian, San Jose, CA (US)

(72) Inventor: David Edward Eramian, San Jose, CA (US)

(21) Appl. No.: 14/041,936

(22) Filed: Sep. 30, 2013

(51) Int. Cl. G06Q 50/30; G06Q 30/02; G06Q 30/06

(52) U.S. Cl. CPC G06Q 50/30; G06Q 30/0629; G06Q 30/0284
USPC 705/26.64

(57) ABSTRACT

There is provided systems and method for minimizing travel costs for use of transportation providers by a user. A user may wish to travel between two locations but may not know a least costly route. Thus, travel routes may be calculated between to location to minimize the monetary cost to the user. The travel routes may be updated or reflect changes in the travel route, such as traffic conditions, tolls, or other travel condition. Additionally, the user may wish to change the travel route to reflect other stops the user may wish to make. The travel route can be updated in real time. The travel route can also be recorded and changes from an agreed upon travel route by the transportation provider may be sent to the user for reporting to a transit authority.

### TECHNICAL FIELD

Example embodiments of the present application relate generally to minimizing transportation costs and other user selected parameters for use of one or more transportation provider(s) by a user, and more specifically to an application to determine a user's least costly and/or shortest travel routes using one or more transportation provider(s) with user selected parameters.

### BACKGROUND

A user may wish to utilize a transportation provider, such as a taxi, car service, subway, train, or other transportation service, to travel between two or more points. However, a user may be unaware of various issues that may have an effect on the total cost of the chosen route, such as traffic delays, tolls, mileage surcharges, and other potential fee incurrences. Additionally, a user may have various preferences for travel, such as a specific time the user must arrive by, a preference for a certain type of transportation (e.g., a personalized car service or subway), or a particular route. Thus, when a user hails a cab or visits a subway station, the user may not choose a least costly route, or may choose a route that does not optimize his preferences. Moreover, events may occur in real time while the user is travelling that may delay the user or cause the user to incur additional costs. Therefore, a route selected to be the cheapest at the outset of a trip may become more costly than an alternative route and/or transportation provider during travel.

### BRIEF DESCRIPTION OF THE DRAWINGS

FIG. 1 is a block diagram of a networked system suitable for implementing the process described herein, according to an embodiment;

FIG. 2 is an exemplary travel environment displaying a plurality of transportation provider options for minimizing an expected monetary cost to a user, according to an embodiment;

FIG. 3A is an exemplary travel environment displaying a travel route with optional merchant location stops for a transaction location determined to minimize an expected monetary cost to a user, according to an embodiment;

FIG. 3B is an exemplary travel environment displaying a travel route with optional mobile seller stops for a transaction location determined to minimize an expected monetary cost to a user, according to an embodiment;

FIG. 4 is an exemplary travel environment with multiple users, start locations and/or destination location with travel routes determined to calculate and minimize an expected monetary cost to each of the users, according to an embodiment;

FIG. 5 is a flowchart of an exemplary process for minimizing an expected monetary cost to a user for a travel route with a plurality of transportation providers, according to an embodiment;

FIG. 6 is a flowchart of an exemplary process for determining a travel route with transaction locations while minimizing an expected monetary cost to a user, according to an embodiment;

FIG. 7 is a flowchart of an exemplary process for determining a travel route for multiple users, start locations, and/or destination location while minimizing an expected monetary cost to each of the users, according to an embodiment; and

FIG. 8 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that facilitate minimizing costs for use of transportation providers, such as variable cost transportation providers, by a user traveling from a first location to a second location. Systems suitable for practicing methods of the present disclosure are also provided.

In certain embodiments, a user may wish to travel from a first location to at least a second location via a transportation provider, such as a taxi provider, a black car (e.g., ‘town car’) provider, a shuttle service, a train service, a subway service, or a limousine service. In various aspects, the transportation provider may be a variable cost or a fixed cost transportation provider. As used herein, the phrase “variable cost transportation provider” is used broadly and generically to refer to any transportation provider in which the price incurred by a user for traveling from a starting location to a destination location is not fixed and/or constant. That is, the actual price incurred by the user for traveling from a first location to a second location may vary depending on one or more factors including, but not limited to, the particular route traveled between the points, total distance traveled between the points, the presence of tolls on the particular route taken between the points, the amount of time spent waiting in traffic, and surcharges for times of peak demand. A non-limiting example of a variable cost transportation provider is a taxi service. The phrase “fixed cost transportation providers” is used to refer to transportation providers that are not variable cost transportation providers. A characteristic of many, but not necessarily all, fixed cost transportation providers is that, for a given provider, the cost of a trip from a first location to a second location is generally identical between multiple trips between these points.

In certain aspects, the user may be presented with options for different routes (e.g., 2 or more routes, such as 3 routes, 4 routes, or 5 routes) to travel between at least a first location and a second location using one transportation provider, such as a variable cost transportation provider. Aspects of certain embodiments also include the user being presented with options for different routes for each of a plurality of different transportation providers. In such embodiments, the different transportation providers may be of the same or different type (e.g., 2 or more variable cost transportation providers), or even the same or different sub-type (e.g., 2 or more taxi providers).

For example, in certain aspects, a user may desire to travel from a first location to at least a second location via a transportation provider, and may utilize an application to communicate with one or more servers in order to find one or more transportation providers for travel to the destination location. The application may receive travel routes for one or more transportation providers between the two locations, where the travel routes are selected to minimize an estimated cost of travel to the user. Accordingly, in certain embodiments routes may be calculated for fixed cost transportation providers, variable cost transportation provider(s), and/or combinations of the two. For each of the transportation providers, the travel routes may be calculated to account for extra costs incurred by traffic, tolls, distance or fuel surcharges, and/or other traffic conditions. The transportation providers may be selected from user input, or may display all transportation providers willing to service the user. For example, the user may select to not consider particular types of transportation providers, such as taxi services, black car or limousine services, or subway services, for various reasons including accessibility (e.g., wheelchair access), personal preference, time constraints, and/or compliance with a travel policy (e.g., a corporate travel policy). Additionally, other parameters may be selected by the user and used as a filter to the displayed transportation providers and routes. Parameters such as stops on the routes, total time of the route, time to reach destination of the route, and/or distance travelled to meet the transportation provider may affect the display of the transportation provider and/or route.

The user may be prompted to select a route and/or a type of transportation provider from among the choices. In certain embodiments, once a user has selected a travel route and/or a transportation provider, the travel server may arrange for the user to meet and/or be connected with the transportation provider and begin the travel route. The transportation application may receive direction for the user to meet the transportation provider. However, in other embodiments, the travel server may notify the transportation provider of the user's location and provide the user with a time to meet the transportation provider. Additionally, when payment for the transportation service is due prior to travel, the travel server may arrange payment using user information and/or a payment provider. In certain embodiments, the travel server may instead arrange payment at the end of the trip, using user information and/or a payment provider. Thus, the user may be provided with a receipt or other payment token for the transportation provider, or may be directed to an area to retrieve the payment token (e.g. a subway card or token).

While travelling, the travel server and/or transportation application may receive updates from traffic services (e.g., services providing real-time or substantially real-time traffic information) corresponding to a selected travel route of the user or the current travel route of the transportation provider. The traffic services may alert the travel server and/or user to potential delays caused by traffic, weather, or other potential warnings. The travel server and/or transportation application may update the travel route to account for the delay. Thus, the user may receive a revised route for use with the current transportation provider, and may also receive revised route(s) which may include the use of one or more other potential transportation provider(s). The revised route may account for a least costly route, or may minimize time spent travelling or other parameter. Additionally, the user may wish to revise a route while travelling to account for preferences in location, time, or cost. Thus, the travel route may be updated in real time and conveyed to the transportation provider(s).

In various embodiments, the travel route may account for various user preferences. In one embodiment, a user may purchase an item ahead of time (e.g., a perishable item such as food, or a good from a merchant), and the travel route may account for a time and cost to travel to a transaction location where the user may retrieve the item. In other embodiments, the transaction location may allow the user to drop off an item to complete a transaction, for example, a sale or repair of an item. The transaction location may correspond to a merchant location, such as a store location. In certain embodiments, the transaction location may instead correspond to a meeting location with a mobile seller, such as an independent seller who can travel to meet the user or a courier employed by a seller.

The travel route modified with the transaction location may correspond to a least costly or fastest time to the user. The user may be charged for use of the courier, wait time at a transaction location, and/or a detour to the transaction location by the transportation provider. Any cost for use of the transaction location may be paid for by the merchant, for example, deducting/paying a pro rata share of the final amount from the transportation provider, or may be credited to a payment provider account corresponding to the user.

In other embodiments, more than one user may share the cost of using a transportation provider and request more than one start location and destination location. The cost may be split, such as splitpro rata, between the users. In some embodiments, a payment provider may be utilized to pay for the transportation provider. The pro rata share may consider costs incurred due to each individual passenger, as well as a pro rata share for the trip. For example, one passenger may require a travel route passing through a toll. Thus, that passenger may only incur the fee for the toll. However, in various embodiments, all passengers may agree to split or pay part of the toll due to the ride sharing aspect of the travel route.

When more than one user wishes to share a cost of using a transportation provider, the users may receive information about the other passenger(s). Such information may correspond to a contact option to get in touch with the other passengers, contact information, and/or a social networking profile. The users and/or the transportation provider may arrange pick up at one or more locations for the passengers. Additionally, the application may enable payment through a payment provider utilizing pro rata shares of the travel costs. Thus, the passengers may easily calculate and pay their share.

In some embodiments, a user may set up an account with a payment provider including user financial and/or personal information. The payment provider may include information corresponding to the consumer's credit cards, bank accounts, or other financial accounts. Additionally, a user device (e.g., a mobile device such as a smartphone, tablet, netbook or notebook, a wearable device, etc.) may install a payment account application or other financial application from the payment provider on the user device, or the transportation application may provide payments using the payment provider. When the user reaches a destination point on the travel route, the user may utilize the payment provider to provide payment for the transportation services. In other embodiments, payment for the transportation services may be arrange up front, or prior to the transportation service, such as purchasing a subway pass, bus ticket, or other pre-travel payment token.

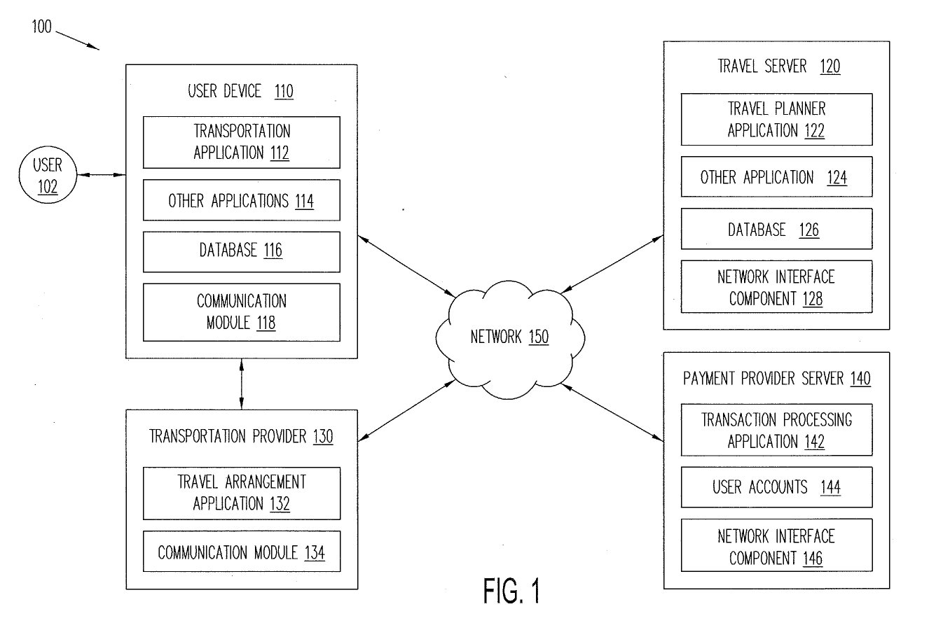

FIG. 1 is a block diagram of a networked system 100 suitable for implementing the process described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a travel server 120, a transportation provider 130, and a payment provider server 140 in communication over a network 150. User 102, such as a traveler, may utilize user device 110 to location a transportation provider and determine a least costly (e.g. a travel route determined to minimize at least an estimated monetary cost to user 102) and/or shortest travel route to a destination point. In certain embodiments, user device 110 may receive travel routes for a plurality of different transportation providers and/or transportation services including a variable cost transportation provider. The travel routes may further take into account travel times, traffic, and/or other user preferences. The travel routes may also account for a transaction location for an item. In various embodiments, user device 110 may receive detour routes and/or stops on a travel route corresponding to a transaction location for the item, along with expect costs and travel/wait times incurred during travel. In various embodiments, user device 110 may be configured to receive travel routes for one or more other users and/or alert user 102 of other users that share the same or similar start locations and/or destination locations.

User device 110, travel server 120, transportation provider 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented using any appropriate hardware and software configured for wired and/or wireless communication travel server 120, transportation provider 130, and payment provider server 140. For example, in one embodiment, user device 110 may be implemented as a personal computer (PC), a smart phone, personal digital assistant (PDA), laptop computer, wristwatch with appropriate computer hardware resources (e.g., SAMSUNG GALAXY GEAR®), eyeglasses with appropriate computer hardware (e.g. GOGGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a transportation application 112, other applications 114, database 116, and a network interface component 118. Transportation application 112 and other applications 114 may correspond to processes, procedures, and/or applications executable by a hardware processor, for example, a software program. In other embodiments, user device 110 may include additional or different software as required.

Transportation application 112 may correspond to an application, such as a software application for execution by one or more hardware processors of user device 110, enabling user 102 to find a plurality of transportation providers offering transportation services between a start location and a destination location of user 102, receive travel routes selected to minimize an expected monetary cost to the user, receive a selection of the travel routes, and update a transportation server and/or transportation provider to arrange for travel of user 102. Transportation application 112 may further receive travel routes including transaction locations, which may correspond to a merchant location and/or a mobile seller including a courier meeting location. The travel routes may include detours to the transaction location, or may include the locations on the travel route, where each location may include an expected monetary cost and/or wait time for the transaction. Moreover, in some embodiments, travel application 112 may receive travel routes for one or more other users nearby user 102 and/or sharing a similar destination location to user 102, such as a destination location within a certain radius (e.g., 2 miles or less, such as 0.5 miles or 0.1 miles) from the destination location of user 102. Travel application 112 may further receive profiles for the other users and cost savings for travelling with the other users, including an expected pro rata portion of an expected monetary cost for user 102 to travel with the other users.

Transportation application 112 may enable user 102 to set, view, and change account information and settings, such as user information including user personal information, user billing/shipping information, user financial information, and other user account information. Transportation application 112 may also receive and store information, such as travel cost receipts, travel routes taken, and costs/time of alternative travel routes for one or more transportation providers.

Transportation application 112 may be activated by user 102 when user 102 wants to travel to a destination endpoint. Transportation application 112 may receive a start location of a user, such as through user input and/or or another application of user device 110 (e.g. a GPS locator and application or other mapping application). Transportation application 112 may further receive a destination endpoint of user 102, such as through user input and/or another application (e.g., integration with a scheduling or calendar application containing information about the location(s) and time(s) of upcoming appointments of the user 102). Other input may be entered prior to or during selection of a travel route, such as user preferences including type of transportation/transportation provider, brand/name of transportation provider, time of travel, route of travel including potential travel fees, or other preference. Other input may further include a request to visit a merchant or arrange a mobile seller (e.g. a courier service, delivery server, or seller with transportation means) to drop off an item along the travel route. Additionally, user 102 may select a preference to utilize ride sharing and select a number of additional users to travel with and a parameter corresponding to a distance/cost of the start location and/or destination location of the other users. Once sufficient information is entered to transportation application 112, transportation application 112 may transmit the information to a server, such as travel server 120, for processing.

Transportation application 112 may receive one or more travel routes for one or more transportation providers based on the input transmitted to travel server 120. Travel routes may be determined as will be discussed in greater detail herein. User 102 may utilize transportation application 112 to select one of the travel routes and arrange travel with the transportation provider. Transportation application 112 may transmit the selection over network 150 to travel server 120, where travel server 120 contacts a transportation provider, such as transportation provider 130, to arrange travel. However, in other embodiments where user 102 may be local to transportation provider 130, user device 110 may contact transportation provider 130 to arrange travel, including transmitting the travel route to the transportation provider.

Transportation application 112 may display a location of transportation provider 130 so that user 102 may walk, bike, etc. to transportation provider 130. In other embodiments, user device 110 and/or travel server 120 may transmit the start location of user 102 to transportation provider 130 and may alert user 102 when transportation provider 130 is local to user 102.

Transportation application 112 may receive updates from travel server 120 during the travel route. Updates may correspond to traffic conditions, weather conditions, new users that would like to travel with user 102, transaction locations, and/or other potential traffic condition that may change the travel route. In other embodiments, user 102 may select to alter the travel route directly, for example, to visit a landmark, friend, merchant, or other potential detour. Transportation application 112 may transmit an updated route to travel server 120 and/or transportation provider 130 so that the travel route may be updated accordingly. When updating the travel route, a new expected cost including a lowest potential cost for the update route may be displayed to user 102.

Transportation application 112 may further include a process to pay for the travel route with the transportation provider. Transportation application 112 may therefore provide user information, such as user financial information, to complete a payment for the travel route. Additionally, transportation application 112 may utilize a payment provider, such as payment provider server 140, to complete payment using a payment service. Thus, transportation application 112 may include processes to complete payment using the payment provider server 140 and may utilize a user account of user 102 with payment provider server 140. Payment may be due before or after travel with the transportation provider.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. Other applications 114 may include a browser application enabling user 102 to access the Internet and various services discussed herein. In various embodiments, other applications 114 may include a payment application, such as an application corresponding to payment provider server 140 and used to complete payments for items, including travel routes/costs. In various embodiments, the payment application may be maintained by PayPal®, Inc. of San Jose, Calif. Other applications 114 may include a GPS and/or other mapping or location services applications. Additionally, a social networking application may be include in other application 114 and utilized to provide a social networking profile for transportation application 112, find other users sharing same or similar start and destination locations, and view the other users social networking profiles. However, these functions may also be incorporated within transportation application 112 directly. Other applications 114 may include merchant applications enabling user 102 to purchase items, locate stores, track couriers, and provide other processes related to the merchant and a transaction location. Other applications 114 may contain software programs, executable by a processor, including a graphical user interface (GUI) configured to provide an interface to the user.

User device 110 may further include database 116 which may include, for example, identifiers such as operating system registry entries, cookies associated with transportation application 112 and/or other applications 114, identifiers associated with hardware of user device 110, or other appropriate identifiers, such as identifiers used for payment/user/device authentication or identification. In one embodiment, identifiers in database 116 may be used by a travel server and/or payment provider, such as travel server 120 and/or payment provider server 140, to associate user device 110 with a particular account maintained by the server.

In various embodiments, database 116 may further include user information or data to access user information. Thus, database 116 may include user personal information (e.g. a name, social security number, user financial information, or other identifying information), a user account identifier, and a user device identifier. In various embodiments, database 116 may include online account access information. Database 116 may also store travel information, such as past travel receipts and travel routes. Database 116 may store comparisons between selected travel routes and other offered travel routes. Thus, stored travel routes and receipts may be utilized to provide an account of travel expenses to an employer and a comparison of other potential travel expenses. Database 116 may include stored locations and/or travel routes for quick recall in the case of preferred routes.

User device 110 includes at least one communication module 118 adapted to communicate with travel server 120, transportation provider 130, and/or payment provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Travel server 120 may be maintained, for example, by an online travel provider, which may provide travel service including arrangement of travel, determination of travel routes, updating of travel routes, and other travel related services. In this regard, travel server 120 includes one or more processing applications which may be configured to interact with user device 110, transportation provider 130, and/or payment provider server 140 to facilitate completion of travel arrangements. Additionally, travel server 120 may provide other services related to travel, including arrangement for travel routes with detours and/or stops for merchants and/or mobile sellers and social networking services for two or more user with the same or similar start and destination points to arrange a travel sharing plan. In one example, travel server 120 may be included within a merchant server, such as one maintained by Ebay®, Inc. of San Jose, Calif., USA. However, in other embodiments, travel server 120 may be maintained by or include a payment provider, transportation provider or other service provider.

Travel server 120 of FIG. 1 includes a travel planner application 122, other applications 124, database 126, and a network interface component 128. Travel planner application 122 and other applications 124 may correspond to processes, procedures, and/or applications executable by a hardware processor, for example, a software program. In other embodiments, travel server 120 may include additional or different software as required.

Travel planner application 122 may correspond to processes and/or procedures to receive at least one start location and destination location including additional parameters, stops/detours, and/or users, and determine a least costly and/or shortest route between the start and destination location. A least costly route may be determined through minimizing an estimated monetary cost using pricing information for a plurality of transportation providers. Below Table 1 shows an exemplary pricing scheme of a transportation provider used to determine an estimated monetary cost.

TABLE 1

| | |
|---|---|
| First one-fifth mile of travel | $3.50 |
| Each additional one-fifth mile or fraction thereof | $0.55 |
| Each minute of waiting or traffic time delay | $0.55 |
| Airport surcharge | $2.00 |
| Excessive distance surcharge for trips exceeding | Additional 50% of |
| 15 miles | metered rate |
| Bridge tolls | Borne by passenger |

Travel planner application 122 may determine the least costly and/or shortest route using additional input received from one or more other sources. For example, travel planner application 122 may receive traffic information, including traffic conditions, expected delays, tolls, or other potential fee and/or time delays. Travel planner application 122 may receive information for a purchased item corresponding to a transaction location for the item. The transaction location may correspond to a merchant location, such as a retail storefront. Thus, the transaction location may correspond to a detour off of a selected route. However, the transaction location may also correspond to a mobile seller, such as a courier service, and independent service, and/or a seller with transportation, where the mobile seller may meet user 102 along a selected route or a common detour off the selected route. Travel planner application 122 may receive information for a ride-share service between user 102 and one or more other users, such as a split use of a transportation provider. Travel planner application 122 may also include and/or receive a contact option, including contact information and/or social networking information for each user to utilize while connecting the users for common transportation.

Travel planner application 122 may initially receive information corresponding to a start location and a destination location of user 102 from user device 120. Travel planner application 122 may further receive additional parameters governing a travel route for user 102 from the start location to the destination location. Using the start location, the destination location, and the additional parameters, travel planner application may determine at least one travel route using at least one transportation provider to minimize an expected monetary cost to user 102. In minimizing the expected monetary cost, travel planner application 122 may minimize travel time, travel distance, or cost factor. Additionally, the parameters may filter the result set of the at least one travel route using the at least one transportation provider. For example, user 102 may select to not use subway travel, travel that would require user 102 to walk more than 1 mile to access, or not use a particular brand of transportation provider. User 102 may select other parameters corresponding to desired travel factors, such as wait times, number of stops/detours, traffic conditions, weather conditions, or other factor. Travel planner application 122 may provide various travel routes meeting the set parameters for a comparison by user 102. In other embodiments, travel planner application 122 may select a travel route optimized for user 102 based on the parameters, cost, and/or time.

Travel planner application 122 may further receive information corresponding to stops/detours along a travel route that a user may wish to make. Stops/detours may be chosen by user 102 based on impulses, for example, a tourist location or merchant user 102 may wish to visit. However, in various embodiments, user 102 may purchase an item from a merchant ahead of time. While travelling, such as after arriving in a city and taking a taxi to a hotel, user 102 may be informed of the possibility to pick-up the item user 102 has purchased. User 102 may be informed of transaction locations near the travel route to a destination location and the expect detour time and cost to arrive at each transaction location, including potential wait times at the merchant location. Transaction locations may correspond to a merchant location (e.g. a store or retail location), mobile seller location, or other location to complete an transaction for an item. In some embodiments, the merchant may employ a delivery/courier service. Thus, user 102 may be informed of stop locations along the travel route where the courier may meet user 102, expected wait times for the courier, and expected costs of deviation and/or wait to meet the merchant/courier. Travel planner application 122 may facilitate payment for the courier services, including payment by the merchant and/or user 102. In various embodiments, the merchant may provide payment and/or a credit for waiting for or detouring to the transaction location. Thus, travel planner application 122 may receive the payment/credit and discount it from the current trip or may work with payment provider server 140 to credit an account of user 102 for travel to the transaction location.

Travel planner application 122 may further provide services for user 102 to locate and choose “ride-sharing” services, whereby more than one user utilizes the same transportation provider to travel from the same, similar, and/or different start locations to the same, similar, and/or destination locations. Travel planner application 122 may locate users nearby user 102 sharing a similar destination endpoint and inform both the users and a transportation provider of their respective locations. Moreover, travel planner application 122 may transmit profiles, including social networking profiles to each user to assist each user in deciding whether to travel with the other user. Travel planner application 122 may track the start location of each user and the destination location of each user, and charge each user with a pro rata share of the travel route cost. The pro rata share may account for tolls required for the user's individual start/destination location, traffic caused by a particular user's locations, delays caused by each user or other factor. Additionally, travel planner application 122 may alert, in real time, user 102 and other users of other individuals along a travel route sharing a similar endpoint while travelling.

Once at least one travel route using at least one transaction provider is determined, the travel routes and corresponding transportation providers may be transmitted to transportation application 112 of user device 110. The travel routes and transportation providers may also be transmitted to any additional users who may be selected for sharing transportation with user 102. Once user 102, and any additional users, have selected a transportation provider and travel route, travel planner application 122 and/or transportation application 112 may transmit the travel route and locations of all users to the transportation provider, such as transportation provider 130.

Travel planner application 122 may receive real time traffic conditions and other traffic conditions, such as tolls, road and weather conditions, emergency situations, and/or other potential delays while user 102 is on a travel route with a transportation provider. Thus, travel planner application 122 may update transportation application 112 and/or transportation provider 130 with the traffic updates. Travel planner application 122 may determine a new route minimizing time and/or cost using the same transportation provider, or may provide user 102 with other transportation providers that user 102 may utilize to complete the trip to a destination location.

Travel planner application 122 may track a route the transportation provider is taking and provide notification to user 102 if the transportation provider deviates from an agreed upon route. If user 102 feels uncomfortable raising the issue with the transportation provider, travel planner application 122 may facilitate transmitting reports to a transportation authority, the transportation provider's company, law enforcement authority, and/or a contact of user 102.

Additionally, travel planner application 122 may provide a feature to save travel routes taken and comparisons to other offered travel routes. Travel planner application 122 may facilitate user 102 in reporting travel arrangements to a reimbursement authority, such as an employer of user 102.

In various embodiments, travel server 120 includes other applications 124 as may be desired in particular embodiments to provide features to travel server 120. For example, other applications 124 may include security applications for implementing server-side security features, programmatic server applications for interfacing with appropriate application programming interfaces (APIs) over network 150, or other types of applications. Other application 124 may include applications necessary to perform functions of travel server 120 and/or travel planner application 122 as discussed herein. For example, other applications 124 may include a traffic application configured to accrue traffic information necessary for determine one or more travel routes. Other applications 124 may include a merchant/marketplace application that may offer items for sale to user 102. The merchant/marketplace application may further perform functions such as merchant location identification for pick-up/drop-off of items and/or courier services to arrange stops along a travel route for pick-up/drop-off. Additionally, other applications may include an application to arrange sharing of a travel route with one or more other users, including networking between the users and social networking functions such as profiles and messaging. The aforementioned applications may also reside on another server and other application 124 may include applications to receive and transmit information with the other servers. Other applications 124 may contain software programs, executable by a processor, including a graphical user interface (GUI), configured to provide an interface to a user.

Additionally, travel server 120 includes database 126. As previously discussed, user 102 may establish one or more user accounts with travel server 120. User accounts in database 126 may include user information, such as name, address, birthdate, payment/funding information, and/or other desired user data. User accounts may link to information stored with travel server 120, such as common start/destination locations, preferred transportation providers, stored travel routes, or other information corresponding to user 102. User 102 may link user accounts to user device 110 through a user device identifier. Thus, when a device identifier corresponding to user device 110 is transmitted to payment provider server 130, e.g. from user device 110, a user account belonging to user 102 may be found. In some embodiments, user accounts in database 126 may include identifiers for an account stored with payment provider server 140, such as a payment account. Database 126 may further store common start/destination locations, preferred transportation providers, stored travel routes, or other information corresponding to user 102, as previously discussed.

In various embodiments, travel server 120 includes at least one network interface component (NIC) 128 adapted to communicate with network 150 including user device 110, transportation provider 130, and/or payment provider server 140. In various embodiments, network interface component 128 may comprise a DSL (e.g., Digital Subscriber Line) modem, a PSTN (Public Switched Telephone Network) modern, an Ethernet device, a broadband device, a satellite device and/or various other types of wired and/or wireless network communication devices including microwave, radio frequency (RF), and infrared (IR) communication devices.

Transportation provider 130 may be maintained, for example, by a provider of transportation services to user 102. In this regard, transportation provider 130 includes one or more applications to purchase travel and arrange travel between two or more points using a transportation provider. A transportation provider may be a fixed cost transportation provider or a variable cost transportation provider, and in certain aspects may correspond to at least one of a taxi provider, a town car provider, a shuttle service, a train service, a subway service, and a limousine service. A variable cost transportation provider may refer to any transportation provider in which the price incurred by a user for traveling from a starting location to a destination location is not fixed and/or constant. That is, the actual price incurred by the user for traveling from a first location to a second location may vary depending on one or more factors including, but not limited to, the particular route traveled between the points, total distance traveled between the points, the presence of tolls on the particular route taken between the points, the amount of time spent waiting in traffic, and surcharges for times of peak demand. A non-limiting example of a variable cost transportation provider is a taxi service. A fixed cost transportation provider may refer to transportation providers that are not variable cost transportation providers. A characteristic of many, but not necessarily all, fixed cost transportation providers is that, for a given provider, the cost of a trip from a first location to a second location is generally identical between multiple trips between these points Transportation provider 130 may provide one or more than one of the aforementioned transit services. Thus, transportation provider 130 may be maintained by one or more providers of the aforementioned transit services. In various embodiments, transportation provider 130 may be incorporated within travel server 120 and/or payment provider server 140.

Transportation provider 130 of FIG. 1 includes a travel arrangement application 132 and a communication module 134. Travel arrangement application 132 may correspond to processes, procedures, and/or applications executable by a hardware processor, for example, a software program. In other embodiments, transportation provider 130 may include additional or different software as required

Travel arrangement application 132 may include processes and/or procedures to arrange travel for user 102 after receiving a travel route from user device 110 and/or travel server 120. Travel arrangement application 132 may receive a start location and a destination location and arrange transit between the locations. In various embodiments, travel arrangement application may send a taxi or car service to user 102. However, in other embodiments, travel arrangement application 132 may facilitate the sale of travel tokens/payments to utilize a transit service of transportation provider 130 between the start location and the destination location, for example, using a bus, subway, or other fixed location transportation provider (i.e. a transportation provider travelling prearrange paths and/or travelling to predetermined locations and not varying).

Travel arrangement application 132 may also facilitate updates to a travel route using a transit service of transportation provider 130, such as changes due to traffic, transaction locations, or other travel changes. Travel arrangement application 132 may also facilitate arranging travel for more than one user for use of a service of transportation provider 130, such as a taxi or car service. In various embodiments, travel arrangement application 132 may locate a nearest taxi/car service to user 102 and/or other users, and dispatch the service to user 102 and/or the other users.

Transportation provider 130 includes at least one communication module 134 adapted to communicate with user device 110, travel server 120, and/or payment provider server 140. In various embodiments, communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 140 may be maintained, for example, by an online payment service provider, which may provide payment services and/or processing for financial transactions on behalf of a user with a merchant. In this regard, payment provider server 140 includes one or more processing applications which may be configured to interact with user device 110 and/or merchant device 140 to facilitate completion of a financial transaction. Additionally, payment provider server 140 may provide other financial services, such as account monitoring to determine payments with online merchants and/or recurring payment. In one example, payment provider server 140 may be provided by PayPal®, Inc. of San Jose, Calif., USA. However, in other embodiments, payment provider server 140 may be maintained by or include a credit provider, financial services provider, financial data provider, and/or other service provider, which may provide payment service to user 102.

Transaction processing application 142 may be configured to receive and/or transmit information from user device 110, travel server 120, and/or transportation provider 130 for processing and completion of financial transactions. Transaction processing application 142 may include one or more applications to process financial transaction information corresponding to a travel route of user 102. For example, transaction processing application 142 may complete payment to transportation provider 130. Additionally, transaction processing application 142 may receive monetary credit from merchants, for example, credit for using a courier service, wait times associated with use of the courier service and/or transaction location, fees incurred for use of the courier service, and/or travel to a transaction location. Transaction processing application 142 may further provide an interface for user 102 to enter and complete information corresponding to a financial transaction.

Additionally, payment provider server 140 may include user accounts 144. As previously discussed, user 102 may establish one or more user accounts with payment provider server 140. User accounts 144 may include user information, such as name, address, birthdate, payment/funding information, additional user financial information, and/or other desired user data.

In various embodiments, payment provider server 140 includes at least one network interface component (NIC) 146 adapted to communicate with network 150 including user device 110, travel server 120, and/or transportation provider 130. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

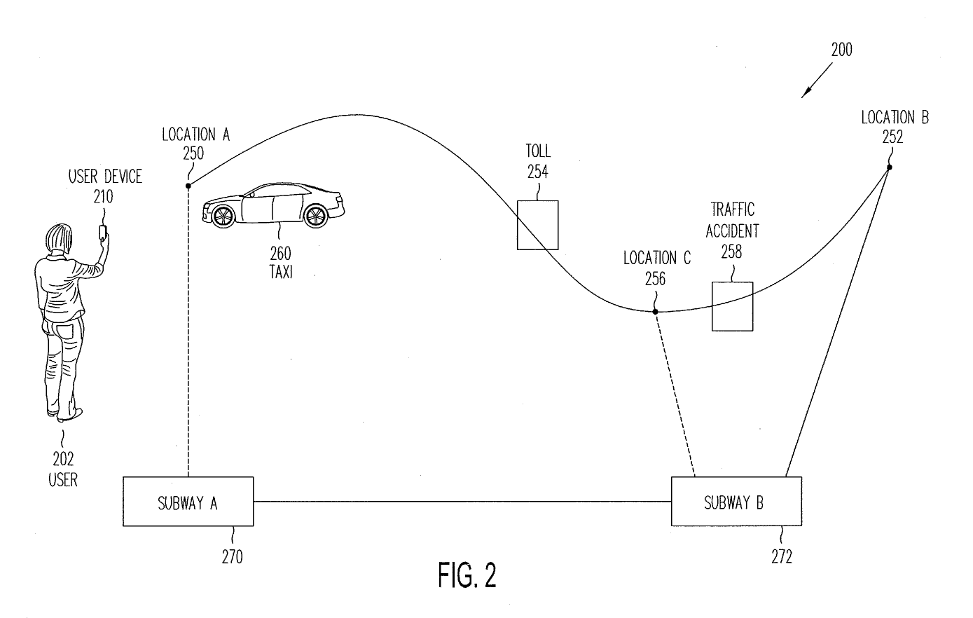

FIG. 2 is an exemplary travel environment displaying a plurality of transportation provider options for minimizing an expected monetary cost to a user, according to an embodiment. A travel environment 200 includes a user 202 with a user device 210 with a desired travel route between a start location and a destination location. User device 210 may provide an option to select from one or more travel routes with a transportation provider in order to complete travel to the destination location. Additionally, user device 210 may be utilized to complete travel arrangements with a selected transportation provider. Thus, user 202 and user device 210 may correspond generally to user 102 and user device 110 of FIG. 1, respectively.

User 202 is located at location A 250 with user device 210 in FIG. 2. User 202 may wish to travel to location B 252. User 202 may utilize an application on user device 210, for example transportation application 112 of FIG. 1, to request a transportation provider to travel between location A 250 and location B 252. User device may transmit location A 250 and location B 252 to a travel server to determine at least one route to location B 252 using at least one transportation provider. Additionally, the travel server may receive additional information that may affect the determination and/or selection of a travel route, such as user preferences and/or parameters related to travel. The travel server may receive and/or request information to determine travel routes using the transportation providers, such as costs of taxi 260, subway A 270, subway B 272, and/or toll 254, delay time or condition of traffic accident 258, and/or other information. In certain aspects, information such as delay time or condition of a traffic accident 258 may be provided via crowd sourced information, scraping structured and/or unstructured data (e.g., social networking sites), real-time traffic data, and the like.

A transportation provider, such as a taxi provider, a town car provider, a shuttle service, a train service, a subway service, and a limousine service may offer one or more services (i.e. taxi, town car/luxury car, shuttle, train, subway, limousine service) to user 102. As shown in FIG. 2, there is a transportation provider offering taxi 260 at location A 250, and at least one other transportation provider offering subway A 270 and subway B 272 at locations between location A 250 and location B 252. For purposes of FIG. 2, it is assumed that the fastest travel, without any delays, from location A 250 to location B 252 is to travel the upper curved road. Also it is assumed that user 202 is required to travel some distance, on foot or by vehicle, to subway A 270 to access subway A 270.

Based on user preferences, parameters related to travel, toll 254, traffic accident 258, and expect travel costs and/or time, user device 210 may then receive from a travel server at least one and possibly more travel routes using taxi 260, subway A 270 and subway B 272. The transmitted travel route may be determined by the travel server to minimize an expected monetary cost to user 202. User device 210 may display one or more of the travel routes based on user preferences and/or parameters. For example, a user may set parameters to avoid use of a subway or spend less than a certain monetary cost threshold. A user preference may limit received and/or displayed travel routes and/or transportation providers to a certain number.

Thus, user device 210 may populate at least one travel route to user 202 between location A 250 and location B 252 using a transportation provider, where the travel route minimizes an expected monetary cost to user 202. In one embodiment, where taxi 260 is the least costly method of transportation between location A 250 and location B 252, user device may display a transportation provider corresponding to taxi 260 to user 202. User 202 may then select the transportation provider and/or travel route, inform the transportation provider, and arrange travel using taxi 260 to location B 252 using user device 210.

However, in other embodiments, taxi 260 may not be the least costly option to travel between location A 250 and location B 252. For example, taxi 260 may be required to travel through toll 260, which may increase the cost of travel. Additionally, traffic accident 258 may require user 202 to wait in taxi 260 while accruing fees. Thus, user device may display instead, or alongside, of taxi 260 and/or the corresponding transportation provider/travel route, a travel route using subway A 270 and/or subway B 270. A cost to use subway A 270 to subways B 272 to reach location B 252 may be lower than to use taxi 260. Thus, user device 210 may display the travel route using subway A 270 and subway B 272, including directions to reach subway A 270. User 202 may then utilize user device 210 to select the alternative travel route using subway A 270 and subway B 272, inform a transportation provider corresponding to subway A 270 and subway B 272, and arrange travel. User device 210 may also facilitate purchasing a ticket, card, or token to utilize subway A 270 and/or subway B 272 prior to arrive at the respective subway locations.

A travel server may also transmit a mix of various transportation providers based on cost, time allotments, and/or travel parameters. For example, a distance to subway A 270 may be too far to walk, user 202 may set a preference to avoid foot travel (e.g. if travelling with children, luggage, etc.), or user 202 may request use of taxi 260 to subway A 270. Thus, the travel server may transmit a travel route to user device 210 including utilizing taxi 260 to arrive at subway A 270, taking subway A 270 to subway B 272, and using subway B to arrive at location B 252. In another embodiment, in order to avoid traffic accident 258, the travel server may transmit a travel route to user device 210 including taking taxi 260 to location C 256, walking or detouring using taxi 260 to subway B 272, and using subway B 272 to arrive at location B 252.

In various embodiments, a travel server and/or user device 210 may receive alerts of traffic conditions while user 202 is on a travel route. For example, traffic conditions may correspond to an updated toll cost along a travel route, such as an increase in toll 254. Additionally, traffic conditions along a travel route may correspond to traffic accident 258. Other travel alerts may include weather conditions, transaction locations, merchant stops, courier locations, and/or other user locations.

When a traffic condition impedes a travel route and causes the travel route to become more costly, user device 210 and/or a travel server may update the travel route to minimize the monetary cost of the travel route. For example, traffic accident 258 may occur after user 202 is traveling using taxi 260 between location A 250 and location B 252. User device 210 may inform user 202 of traffic accident 258 and request or automatically update the travel route by stopping and/or detouring at location C 256 so that user 202 may utilize subways B 272 to arrive at location B 252. Thus, user 202 receives alerts in real-time to maintain a least costly route to user 202. In other embodiments, user 202 may further request travel alerts to update a travel route based on other parameters, such as trip length and/or time.

User device 210 and/or a travel server may store a travel route taken using any of taxi 260, subways A 270, and/or subway B 272 for later use. For example, user 202 may review a travel route taken and if a transportation provider of taxi 260 deviated from a least costly and/or agreed upon route. User device 210 and/or the travel server may facilitate reporting to a transit authority or a supervisor at the transportation provider. In other embodiments, user 202 may be enabled to report in real time to the transit authority, supervisor, contact of user 202, law enforcement authority, and/or other contact if user 202 believes the transportation provider is deviating from the travel route or providing an unsafe travel experience. Additionally, the stored travel routes may be utilized for reporting to an employer (e.g. a workplace supervisor) of user 202 for reimbursement. The stored travel routes may include comparisons to cost and/or time for other transportation providers as well so as to, for example, illustrate that user 202 was acted reasonably in selecting the transportation provider, so as to facilitate reimbursement or compliance with a corporate travel policy.

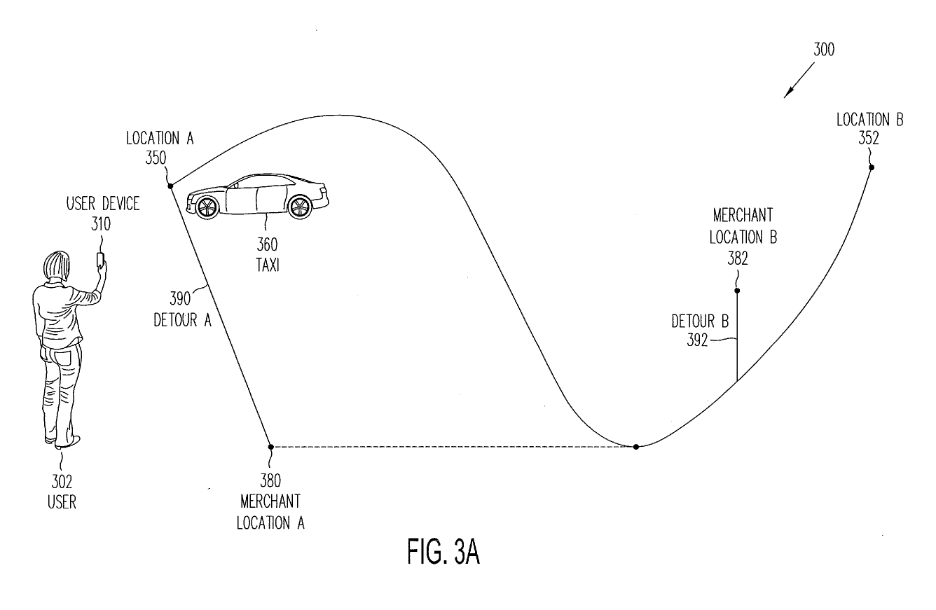

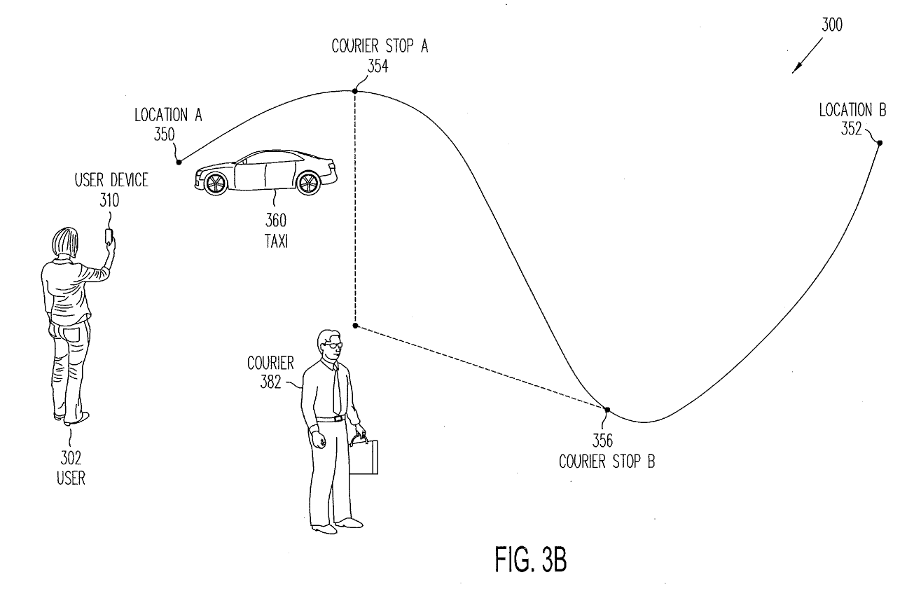

FIG. 3A is an exemplary travel environment displaying a travel route with optional merchant location stops for a transaction location determined to minimize an expected monetary cost to a user, according to an embodiment. A travel environment 300 includes a user 302 with a user device 310 with a desired travel route between a start location and a destination location. User device 310 may provide an option to select a travel route with a transportation provider and complete travel arrangements with a selected transportation provider. User 302 may purchase an item prior to traveling on a selected travel route. Thus, user device 310 may also facilitate transaction locations corresponding to a merchant and/or merchant courier along on near the travel route. In FIG. 3A, user 302 and user device 310 may correspond generally to user 102 and user device 110 of FIG. 1, respectively.

User 302 may purchase an item from a merchant or desire to drop off an item with a merchant (e.g. for repair or refund). User 302 may do this prior to arriving at location A 350 and/or while at location A 350. For example, location A 350 may correspond to an airport, where user 302 has arrived at the airport and wishes to pick-up/drop-off an item previously purchased or purchased while waiting at the airport. Additionally, user 302 wishes to travel from location A 350 to location B 352. Thus, as discussed in reference to FIG. 2, user 302 may utilize user device 310 to arrange a travel route with a transportation provider between location A 350 and location B 352. As shown in FIG. 2, user 302 selects to use taxi 360 to travel between location A 350 and location B 352.

In addition to arranging a travel route between location A 350 and location B 352 as discussed here, user 302 may also request a pick-up/drop of the purchased item. In another embodiment, user 302 may purchase an item while with the transportation provider on the travel route, or desire to drop-off an item while on the travel route, and request pick-up/drop-off of the item while travelling. Thus, user device 210 and/or a travel server may plan a deviation/detour to arrive at a transaction location corresponding to the item. Merchant location A 380 and merchant location B 352 may correspond to a merchant providing services associated with the item, such as store location. User device 310 and/or the travel server may then recalculate the travel route in order to minimize an expected monetary cost to arrive at the transaction location and/or wait times at the transaction location. As shown in FIG. 3A, detour A 390 and detour B 392 will take user 302 to merchant location A 380 and merchant location B 382, respectively. However, the distance along detour B 392 is significantly shorter than detour A 390, and accrues more fees with taxi 360. Therefore, user device may display a travel route including detour B 392 to merchant location B 382 based on a least costly travel route. In other examples, additional information may make detour A 390 fast than detour B 392, such as traffic conditions on detour B 392 or nearby detour B 392.

In another embodiment, user 302 may request to arrive at the transaction location as quick as possible, and thus request a travel route is updated with detour A 390 to merchant location A 380. Therefore, a travel route may be updated with a least costly deviation to take detour A 390 and arrive at merchant location A 380. After taking detour A 390 or detour B 392, the travel route may calculate a least costly travel route to location B 352, which may include taking detour A 390 or detour B 392 back to the original travel route, or altering the travel route as necessary to maintain a least costly travel route.

Additionally, the travel route to merchant location A 380 and/or merchant location B 382 may include wait times at the respective merchant locations. Thus, if an expected wait time, store hour, or other delay may cause a transportation provider, such as taxi 360, to accrue additional fees at the transaction location, the travel route will be adjusted accordingly. For example, an expected wait time at merchant location B 382 may be 30 minutes, while merchant location A 380 only 5 minutes. Thus, detour A 390 may be selected to merchant location A 380 to minimize the expected monetary cost of the travel route.

FIG. 3B is an exemplary travel environment displaying a travel route with optional mobile seller stops for a transaction location determined to minimize an expected monetary cost to a user, according to an embodiment. A travel environment 300 includes a user 302 with a user device 310 with a desired travel route between a start location and a destination location. User device 310 may provide an option to select a travel route with a transportation provider and complete travel arrangements with a selected transportation provider. User 302 may purchase an item prior to traveling on a selected travel route. Thus, user device 310 may also facilitate transaction locations corresponding to a merchant and/or merchant courier along on near the travel route. In FIG. 3B, user 302 and user device 310 may correspond generally to user 102 and user device 110 of FIG. 1, respectively.

User 302 may request, or a merchant may offer, delivery service for an item at a transaction location. A merchant may correspond to a mobile seller, such as a seller with transportation services, a delivery service and/or a courier service. For example, courier 382 may meet user 302 prior, during, or after a travel route to pick-up an item or drop-off an item with user 302. In FIG. 3B, courier 382 may meet user 302 while user 302 travels with taxi 360 along a travel route from location A 350 to location B 352. However, user 302 may be required to stop to meet courier 382, for example, at courier stop A 354 and/or courier stop B 356. The travel route, include the stop for courier 382, may be optimized to provide a least costly travel route to user 302. For example, courier stop A 354 may require user 302 in taxi 360 to wait 15 minutes for courier 382. However, if courier 382 meets user 302 later at courier stop B 356, user 302 in taxi 360 may be required to wait only 5 minutes due to additional travel time by user 302. Thus, the accrued fees for user 302 in taxi 360 will be less at courier stop B 356, and the travel route will include courier stop B 356.

In various embodiments, price to utilize courier may be factored in. For example, the distance travelled by courier 382 to courier stop B 356 may accrue additional fees for use of courier 382. Thus, it may be more expensive to meet at courier stop B 356 even though the wait is longer at courier stop A 354. In other embodiments, a merchant may provide payment for courier services and/or may reimburse user 302 for costs of taxi 360 accrued for waiting at courier stop A 354 or courier stop B 356. The reimbursement may be give as a store credit, payment to a transportation provider corresponding to taxi 360, credit to the transportation provider, and/or credit in a user account of user 302 with a payment provider.

Courier 382 may correspond to, in various embodiments, a delivery service or a seller with transportation. Thus, price to utilize courier 382 may not be a factor in determining which of courier stop A 354 and courier stop B 356 to utilize. In such embodiments, user 302 may be given a choice with expected wait time, increase in cost of taxi 360, or time delays caused by any detour to courier stop A 354 and courier stop B 356. Thus, user 302 may make a decision that is most suitable to the various needs of user 302.

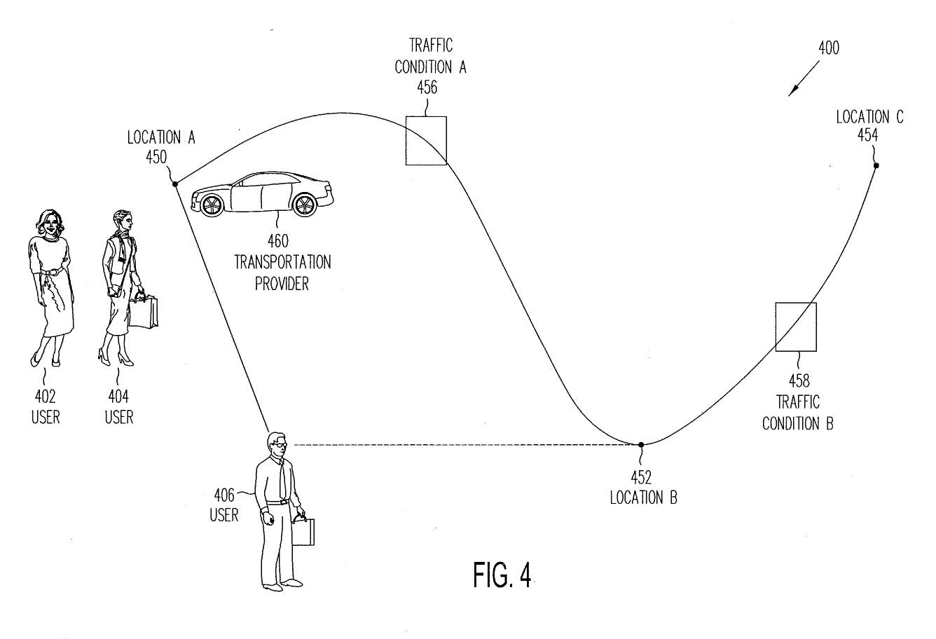

FIG. 4 is an exemplary travel environment with multiple users, start locations and/or destination location with travel routes determined to calculate and minimize an expected monetary cost to each of the users, according to an embodiment. A travel environment 400 includes a user 402 and a user 404 with desired travel routes between a start location and different destination locations. Additionally, a user 406 corresponds to another start location and sharing a desired endpoint with one of users 402 and 404. Each of users 402, 404, and 406 may utilize a corresponding user device to determine a least costly travel route between the start locations and the destination locations. Additionally, the user devices may assist each of users 402, 404, and 406 with determining a pro rata portion of an expected monetary cost to use a transportation provider. Thus, the user devices may also facilitate determining shortest travel routes between each respective start location and destination location corresponding to users 402, 404, and 406, and determine a cost to each user.

FIG. 4 includes a location A 450 where users 402 and 404 are located. Users 402 and 404 may know each other and agree to share a ride at a location. However, in various embodiments, users 402 and 404 may not know each other but request transportation to one or both of location B 452 and location C 454 from location A 450 at or around the same time. Thus, users 402 and 404 may utilize a transportation application on respective user devices to request a travel route using a transportation provider between location A 450 and location B 452/location C 454. The travel application may return a result using transportation provider 460 to location B 452/location C 454 with a pro rata portion of an expected monetary cost. Each of user 402 and 404 may then utilize transportation provider 460 to location B 452/location C 454 and pay an actual pro rata portion of the actual monetary cost for the travel route. Additionally, the travel route may be optimized to minimize the monetary cost to users 402 and 404.

For example, user 402 may wish to travel from location A 450 to location B 452, while user 404 may wish to travel from location A 450 to location C 454. Traffic condition A 456 may correspond to a toll along a travel route, while traffic condition B 458 may correspond to a traffic accident along the travel route. User 402 and 404 may each utilize a transportation application on respective user devices and be informed they are in close proximity to each other. Thus, users 402 and 404 may select to utilize transportation provider 460 together to lessen the financial cost of the travel route. Prior to choosing to use transportation provider 460 with users 402 and 404, users 402 and 404 may receive a contact option corresponding to user 402 and 404. The contact option may include contact information, a name of the other user, a social networking profile of the other user, previous reviews of travelling with the other user by additional users of the transportation application, or other user information.

The transportation application may arrange travel for users 402 and 404 and inform transportation provider 460 and/or users 402 and 404 of the information necessary to utilize transportation provider 460 (e.g. location of transportation provider 460, names and/or locations of users 402 and 404, or other information). Users 402 and 404 may be informed of the travel route and a pro rata portion of an expected monetary cost. Users 402 and 404 may then travel to location B 452 where user 402 leaves transportation provider 460 and splits the cost evenly with user 404, including the cost of the toll at traffic condition A 456. Since only user 404 continues to location C 454, user 404 then pays the rest of the cost of the travel route to location C 454, including the cost of the delay caused by traffic condition B 458. In other embodiments, cost may be split differently to account to the ride-sharing aspect of use of transportation provider 460. Actual pro rata portions of an actual monetary cost may be determined and transmitted to users 402 and 404, or may be negotiated by users 4092 and 404.

In other embodiments, users 402 and 404 may be located at different start locations and request the same (e.g., an airport, or a hotel) or different destination locations. Thus, each user will pay a pro rata portion of the travel cost based on their use of transportation provider 460. For example, where user 402 is picked up by transportation provider 460 prior to user 404, user 402 may pay for the cost to reach user 404. However, if user 404 is out of the way of the travel route, user 404 may split the cost to reach user 404, as user 402 would not normally incur the travel cost of the travel route to reach user 404. Additionally, in some embodiments, location B 452 may require a detour from a travel route to reach location C 454 (i.e. not be on a direct travel route from location A 450 to location C 454). Thus, if user 402 wishes to detour from a travel route between location A 450 and location C 454 to reach location B 452, user 402 may be required to pay some portion of the cost for user 404 to reach location C 454 due to the detour from a least costly travel route for user 404.

In various embodiments, traffic condition A 456 and/or traffic condition B 458 may be caused by a travel route of only one of user 402 or user 404. For example, a delay caused by detouring to reach location B 452, or a stop at location B 452 in order to drop off user 402, may cause user 404 to be delayed by a traffic accident at traffic condition B 458. Thus, user 402 may be required to pay a portion of user 404's travel to location C 454 caused by the delay. In other embodiments, a travel route by one of user 402 or user 404 may cause transportation provider 460 to travel through a toll. For example, user 402's travel route to location B 452 may require transportation provider 460 to travel through traffic condition A 456, which corresponds to a toll bridge. Thus, user 402 may incur the charge for the toll where user 404 would not necessarily have to travel through traffic condition A 456.

In other embodiments, users 402 and 404 may pick up user 406 during travel on a travel route to location B 452. As shown in FIG. 4, user 406 represents a second travel route to location B 452. However, user 406 may represent a detour from a least costly travel route from location A 450 to location B 452. Thus, if users 402 and 404 agree to pick up user 406, user 406 may be required to pay a pro rata portion of a monetary cost to reach location B 452 caused by a detour to pick up user 406. The pro rata portion for user 406 may be larger than ones for user 402 and 404 to account for the deviation. In other embodiments, additional users, start locations of users, destination locations users, and/or travel fees (e.g. tolls, traffic delays, etc.) may all cause differences between pro rata portions of a cost of a travel route for each user.

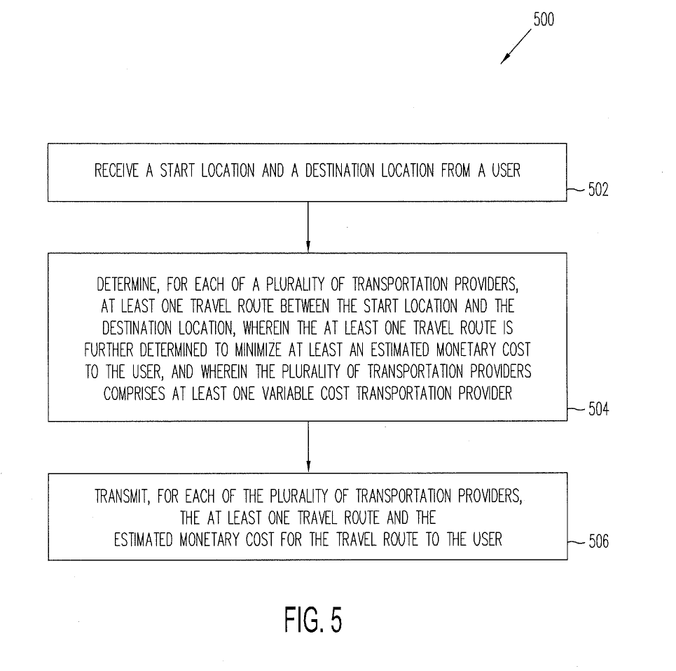

FIG. 5 is a flowchart of an exemplary process for minimizing an expected monetary cost to a user for a travel route with a plurality of transportation providers, according to an embodiment. Note that one or more steps, processes, and methods described herein may be omitted, performed in a different sequence, or combined as desired or appropriate.

At step 502 a start location and a destination location is receive from a user at a server, for example, travel server 120. The start location may correspond to a location the user is currently at or would like to begin a travel route. The destination location may include an endpoint to a travel route. The start and destination location may correspond to a specific address, or may be generalized to account for fixed stop points of a transportation provider.

For each of a plurality of transportation providers, at least one travel route between the start location and the destination location is determined, wherein the at least one travel route is further determined to minimize at least an estimated monetary cost to the user, and wherein the plurality of transportation providers comprise at least one variable cost transportation provider, at step 504. The server may further determine the at least one travel route to minimize at least one of a time traveled by the user and a distance traveled by the user. Additionally, the plurality of transportation providers may include at least one of a taxi provider, a town car provider, a shuttle service, a train service, a subway service, and a limousine service.

At step 506, for each of the plurality of transportation providers, the at least one travel route and the estimated monetary cost for the travel route is transmitted. The at least one travel route and the estimated monetary cost may be transmitted to a user device for display to a user. Additionally, a server may receive a selection from the user indicating a desired travel route using a desired transportation provider from the plurality of transportation providers. The server may transmit the desired travel route to the desired transportation provider, including, in various embodiments, user information corresponding to the user.

The user may receive a comparison between the travel route for each of the plurality of transportation providers, wherein the comparison is based one expected travel time and expected travel cost. The comparison may be stored by a server and/or a user device for later recall.

In various embodiments, a user may be detected travelling on a selected travel route and the travel route updated. The updated travel route may be sent to the user and/or a selected transportation provider. The travel route may be updated using at least one of traffic conditions on the travel route, traffic accidents on the travel route, expected wait times on the travel route, and expected toll rates on the travel route.

Additionally, when a user selects a desired travel route, the user may be given a report option if an actual travel route deviates from the desired travel route. The report option may correspond to a message to at least one of a transit authority corresponding to the one of the plurality of transportation providers, a supervisor corresponding to the one of the plurality of transportation providers, a law enforcement contact, and a contact corresponding to the user.

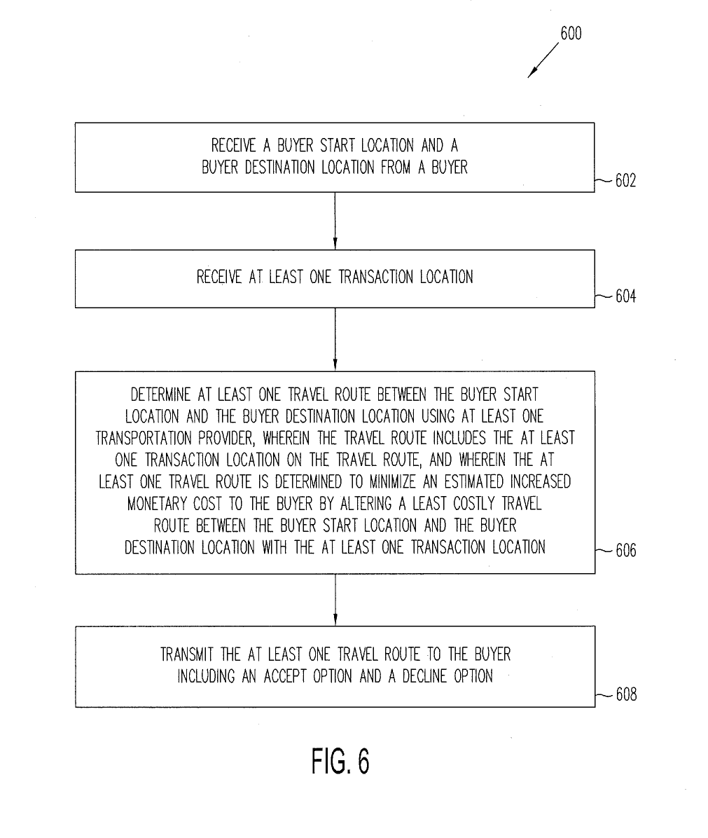

FIG. 6 is a flowchart of an exemplary process for determining a travel route with transaction locations while minimizing an expected monetary cost to a user, according to an embodiment. Note that one or more steps, processes, and methods described herein may be omitted, performed in a different sequence, or combined as desired or appropriate.

At step 602, a buyer start location and a buyer destination location is received from a buyer at, for example, a server, such as travel server 120. The buyer start location may correspond to a location the buyer is currently at or would like to begin a travel route. The buyer destination location may include an endpoint to a travel route. The buyer start and destination location may correspond to a specific address, or may be generalized to account for fixed stop points of a transportation provider.

At step 604, at least one transaction location is received. The transaction location may correspond to at least one store location of a seller, such as a merchant storefront or other merchant physical location. The transaction location may also correspond to a meeting location between a buyer and a mobile seller. A mobile seller may correspond to a seller with transportation services, a delivery service, and/or a courier service (third party or of the sellers).

At least one travel route between the buyer start location and the buyer destination location is determined using at least one transportation provider, wherein the travel route includes the at least one transaction location on the travel route, and wherein the at least one travel route is determined to minimize an estimated increased monetary cost to the buyer by altering a least costly travel route between the buyer start location and the buyer destination location with the at least one transaction location, at step 606. The at least one travel route may be further determined to minimize a wait time for the buyer at the at least one transaction location.

At step 608, the at least one travel route is transmitted to the buyer with an accept option and a decline option. If the accept option is selected, the transaction location may be transmitted to a transportation provider and, if a mobile seller is utilized, to the mobile seller. However, if the decline option is selected, the buyer destination location may be transmitted to the transportation provider and, if the mobile seller is utilized, to the mobile seller. Additionally, if the accept option is selected and the mobile seller is utilized, the mobile seller and/or the merchant may reimburse the buyer for altering the least costly travel route to the travel route to the transaction location.

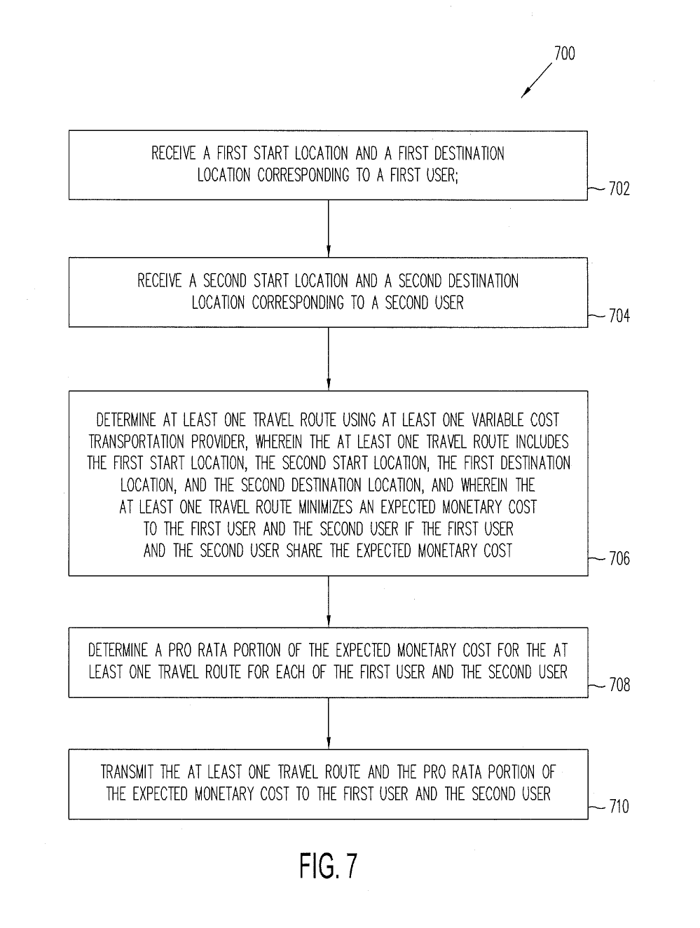

FIG. 7 is a flowchart of an exemplary process for determining a travel route for multiple users, start locations, and/or destination location while minimizing an expected monetary cost to each of the users, according to an embodiment. Note that one or more steps, processes, and methods described herein may be omitted, performed in a different sequence, or combined as desired or appropriate.

At step 702 and 704, a first start location and a first destination location corresponding to a first user, and a second start location and a second destination location corresponding to a second user are received at, for example, a server, such as travel server 120. The start locations may correspond to a location the first and second user are currently at or would like to begin a travel route. The destination locations may include one or more endpoints to a travel route. The start and destination locations may correspond to a specific address, or may be generalized to account for fixed stop points of a transportation provider. In various embodiments, a third start location and a third destination location corresponding to a third user may be received. More users may be added with corresponding start and destination locations if desired.

At step 706, at least one travel route is determined using at least one variable cost transportation provider, wherein the at least on travel route includes the first start location, the second start location, the first destination location, and the second destination location, and wherein the at least one travel route minimizes an expected monetary cost to the first user and the second user if the first user and the second user share the expected monetary cost. Where a third user with a third start location and a third destination location is used, the determining the at least one travel route may further minimize the expected monetary cost to the third user if the first user, the second user, and the third user split the monetary cost. Additionally, fixed costs on the travel route incurred by each individual user may be charged to that user.

A pro rata portion of the expected monetary cost for the at least one travel route for each of the first user and the second user is determined at step 708. Where a third user travels with the first and second user, the pro rata portion of the expected monetary cost may also be determined for the third user.

At step 710, the at least one travel route and the pro rata portion of the expected monetary cost is transmitted to the first user and the second user. Additionally, a contact option may be transmitted to the first user and the second user. The contact option may include contact information and/or a social networking profile. If a third user travels with the first and second user, the third user may receive the travel route, pro rata portion, and/or contact option.

If the first and second user select one of the at least one travel routes using one of the at least one transportation providers, the selected transportation provider may be informed and the first and second user alert of the transportation provider and/or a meeting location of the transportation provider. When the travel route completes, the actual pro rata portion of the actual monetary cost may be determined and transmitted to the first and second user. A payment option using a payment provider may be provided to the first as second user.

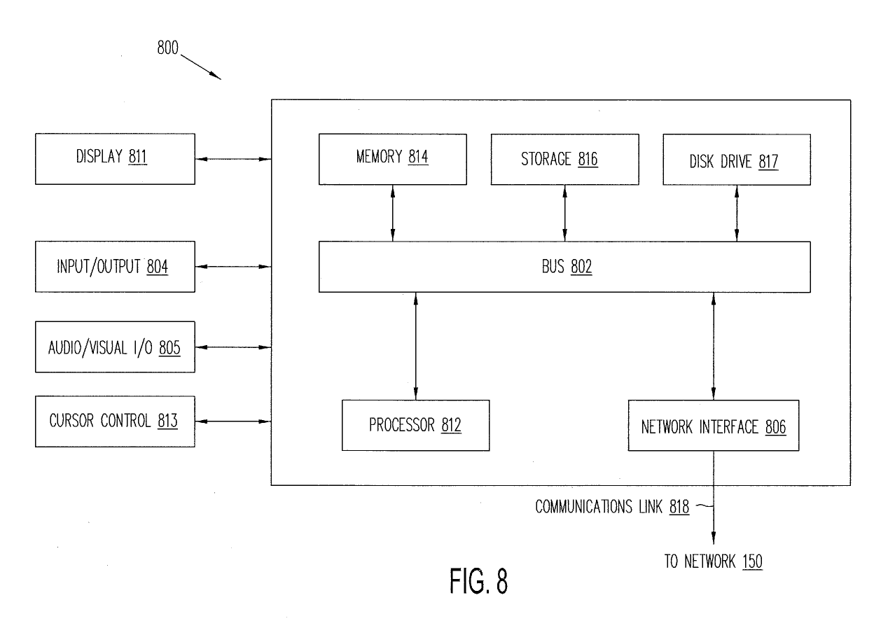

FIG. 8 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, and/or moving one or more images, etc., and sends a corresponding signal to bus 802. I/O component 804 may also include an output component, such as a display 811 and a cursor control 813 (such as a keyboard, keypad, mouse, etc.). An optional audio input/output component 805 may also be included to allow a user to use voice for inputting information by converting audio signals. Audio I/O component 805 may allow the user to hear audio. A transceiver or network interface 806 transmits and receives signals between computer system 800 and other devices, such as another user device, a merchant server, or a service provider server via network 150. In one embodiment, the transmission is wireless, although other transmission mediums and methods may also be suitable. One or more processors 812, which can be a micro-controller, digital signal processor (DSP), or other processing component, processes these various signals, such as for display on computer system 800 or transmission to other devices via a communication link 818. Processor(s) 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor(s) 812 and other components by executing one or more sequences of instructions contained in system memory component 814. Logic may be encoded in a computer readable medium, which may refer to any medium that participates in providing instructions to processor(s) 812 for execution. Such a medium may take many forms, including but not limited to, non-volatile media, volatile media, and transmission media. In various embodiments, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a non-transitory memory storing information corresponding to a plurality of transportation providers; and
one or more hardware processors in communication with the non-transitory memory and configured to:
receive a start location and a destination location from a user using a network interface component;
determine, for each of the plurality of transportation providers, at least one travel route between the start location and the destination location, wherein the at least one travel route is further determined to minimize at least an estimated monetary cost to the user using a schedule of monetary costs comprising at least a location-specific surcharge on the at least one travel route, and wherein the plurality of transportation providers comprises at least one variable cost transportation provider; and
transmit, for each of the plurality of transportation providers, the at least one travel route and the estimated monetary cost for the travel route to the user using the network interface component.

2. The system of claim 1, wherein the one or more hardware processors is further configured to:
receive a selection from the user indicating a desired travel route using a desired transportation provider from the plurality of transportation providers using the network interface component; and
transmit the desired travel route to the desired transportation provider using the network interface component.

3. The system of claim 2, wherein the one or more hardware processors is further configured to:
transmit user information corresponding to the user to the desired transportation provider using the network interface component.

4. The system of claim 1, wherein the at least one travel route is further determined to minimize at least one of an expected time traveled by the user and an expected distance traveled by the user.

5. The system of claim 1, wherein the plurality of transportation providers comprises at least one of a taxi provider, a town car provider, a shuttle service, a train service, a subway service, and a limousine service.

6. The system of claim 1, wherein the one or more hardware processors is further configured to:
provide a comparison between the travel route for each of the plurality of transportation providers, wherein the comparison is based on expected travel time and expected travel cost; and
store the comparison.

7. The system of claim 1, wherein the one or more hardware processors is further configured to:
detect that the user is traveling on the travel route;
update the travel route in real time to obtain an updated travel route; and
transmit the updated travel route to at least the user using the network interface component.

8. The system of claim 7, wherein the updated travel route is predicted to minimize at least a monetary cost to the user relative to the travel route.

9. The system of claim 7, wherein updating the travel route in real time utilizes at least one of traffic conditions on the travel route, traffic accidents on the travel route, expected wait times on the travel route, and expected toll rates on the travel route.

10. The system of claim 1, wherein the one or more hardware, processors is further configured to:
receive a selection from the user indicating a desired travel route from among the plurality of transportation providers using the network interface component; and
provide a report option to the user if an actual travel route deviates from the desired travel route.

11. The system of claim 10, wherein the report option corresponds to a message sent to at least one of a transit authority corresponding to the one of the plurality of transportation providers, a supervisor corresponding to the one of the plurality of transportation providers, a law enforcement contact, and a contact corresponding to the user.

12. A method comprising:
receiving a start location and a destination location from a user using a network interface component;
determining, using one or more hardware processors of a server, for each of a plurality of transportation providers, at least one travel route between the start location and the destination location, wherein the at least one travel route is further determined to minimize at least an estimated monetary cost to the user using a schedule of monetary costs comprising at least a location-specific surcharge on the at least one travel route, and wherein the plurality of transportation providers comprises at least one variable cost transportation provider; and
transmitting, for each of the plurality of transportation providers, the at least one travel route and the estimated monetary cost for the travel route to the user using the network interface component.

13. The method of claim 12 further comprising:
receiving a selection from the user indicating a desired travel route using a desired transportation provider from the plurality of transportation providers using the network interface component;
transmitting the desired travel route to the desired transportation provider using the network interface component; and
transmitting user information corresponding to the user to the desired transportation provider using the network interface component.

14. The method of claim 12, wherein the at least one travel route is further determined to minimize at least one of an expected time traveled by the user and an expected distance traveled by the user.

15. The method of claim 12, wherein the plurality of transportation providers comprises at least one of a taxi provider, a town car provider, a shuttle service, a train service, a subway service, and a limousine service.

16. The method of claim 12 further comprising:
providing a comparison between the travel route for each of the plurality of transportation providers, wherein the comparison is based on expected travel time and expected travel cost; and
storing the comparison.

17. The method of claim 12 further comprising:
detecting that the user is traveling on the travel route;
updating the travel route in real time to obtain an updated travel route, wherein the updated travel route is predicted to minimize at least a monetary cost to the user relative to the travel route; and
transmitting the updated travel route to at least the user using the network interface component.

18. The method of claim 17, wherein updating the travel route in real time utilizes at least one of traffic conditions on the travel route, traffic accidents on the travel route, expected wait times on the travel route, and expected toll rates on the travel route.

19. The method of claim 12 further comprising:
receiving a selection from the user indicating a desired travel route from among the plurality of transportation providers using the network interface component;
providing a report option to the user if an actual travel route deviates from the desired travel route.

20. A non-transitory computer readable medium comprising a plurality of machine-readable instructions which when executed by one or more processors of a server are adapted to cause the server to perform a method comprising:
receiving a start location and a destination location from a user using a network interface component;
determining, using one or more hardware processors of a server, for each of a plurality of transportation providers, at least one travel route between the start location and the destination location, wherein the at least one travel route is further determined to minimize at least an estimated monetary cost to the user using a schedule of monetary costs comprising at least a location-specific surcharge on the at least one travel route, and wherein the plurality of transportation providers comprises at least one variable cost transportation provider;
transmitting, for each of the plurality of transportation providers, the at least one travel route and the estimated monetary cost for the travel route to the user using the network interface component;
receiving a selection from the user indicating a desired travel route using a desired transportation provider from the plurality of transportation providers using the network interface component;
transmitting the desired travel route to the desired transportation provider using the network interface component;
transmitting user information corresponding to the user to the desired transportation provider using the network interface component;
detecting that the user is traveling on the travel route;
updating the travel route in real time to obtain an updated travel route, wherein the updated travel route is predicted to minimize at least a monetary cost to the user relative to the travel route; and
transmitting the updated travel route to at least the user using the network interface component.
